(19) United States
(12) Patent Application Publication
(10) Pub. No.: US 2024/0240274 A1
(43) Pub. Date: Jul. 18, 2024

(54) PIG IRON-PRODUCING METHOD AND IRON ORE MATERIAL

(71) Applicant: Kabushiki Kaisha Kobe Seiko Sho (Kobe Steel, Ltd.), Kobe-shi (JP)

(72) Inventors: Akito KASAI, Kakogawa-shi (JP); Masahiro YAKEYA, Kakogawa-shi (JP); Koji OSUGA, Kakogawa-shi (JP)

(73) Assignee: Kabushiki Kaisha Kobe Seiko Sho (Kobe Steel, Ltd.), Kobe-shi (JP)

(21) Appl. No.: 18/559,427

(22) PCT Filed: Jun. 21, 2021
(86) PCT No.: PCT/JP2021/023437

§ 371 Date: Nov. 7, 2023

(30) Foreign Application Priority Data
Jun. 8, 2021 (JP) 2021-096131

(51) Int. Cl. C21B 5/00

(52) U.S. Cl. CPC C21B 5/008

(57) ABSTRACT

A method for producing pig iron using a blast furnace comprising a tuyere, the method including: charging a first layer containing an iron ore material and a second layer containing coke alternately in the blast furnace; and reducing and melting the iron ore material in the stacked first layer while injecting an auxiliary reductant into the blast furnace by hot air blown from the tuyere, in which: the iron ore material contains a plurality of reduced iron molded products obtained by compression molding reduced iron; the reduced iron molded product is in a rectangular shape chamfered in a plan view, having on both faces a bulge resulting from a center portion being thicker than a peripheral portion; and a length ratio of a longer side to a shorter side of the reduced iron molded product in the plan view is less than or equal to 1.5.

### TECHNICAL FIELD

The present invention relates to a method for producing pig iron, and an iron ore material.

### BACKGROUND ART

A method for producing pig iron by alternately charging a first layer containing an iron ore material and a second layer containing coke alternately in a blast furnace, and reducing and melting the iron ore material while injecting an auxiliary reductant into the blast furnace by hot air blown from a tuyere is known. During this, the coke serves as a heat source for melting the iron ore material, a reducing agent for the iron ore material, a recarburizing agent for carburizing the molten iron to lower the melting point, and a spacer for ensuring gas permeability in the blast furnace. Due to the coke maintaining gas permeability, descent of the burden is stabilized, and in turn, stable operation of the blast furnace is enabled.

In operation of a blast furnace, it is preferred that a proportion of the coke is low in light of cost reduction. However, decreasing the proportion of the coke decreases the role played by the coke. For example, as a method of decreasing the proportion of the coke, in other words increasing the proportion of the iron ore material, a method for operating a blast furnace using reduced iron has been proposed (see Japanese Unexamined Patent Application Publication No. 2015-199978). In the method for operating a blast furnace described above, operation of the blast furnace without increasing the high temperature gas permeability resistance is made possible by blending the reduced iron and the acidic lump ore beforehand and charging to the blast furnace.

### PRIOR ART DOCUMENTS

### Patent Documents

Patent Document 1: Japanese Unexamined Patent Application Publication No. 2015-199978

### SUMMARY OF THE INVENTION

### Problems to be Solved by the Invention

The conventional method for operating a blast furnace described above takes advantage of the reduced iron which is a material hard to pulverize, to maintain a gas flow in a shaft portion in such a manner that the reduced iron maintains its shape and serves as an aggregate even when other iron ore materials are pulverized. Therefore, in the conventional method for operating a blast furnace described above, strength of the reduced iron is required and it is essential that the reduced iron is in a briquette form with a great apparent density. However, increasing the apparent density causes the reduced iron to accumulate in a lower layer, generally referred to as segregation, and the effect of improving gas permeability due to the reduced iron is not attained. Since such an influence is remarkable when the size of the reduced iron is great, in the conventional method for operating a blast furnace described above, a balance between the strength of the reduced iron and inhibition of segregation is achieved by increasing the grain size of the reduced iron in accordance with to the apparent density. However, the above-described balanced point does not provide a sufficient effect of improving gas permeability, and further improvement of the gas permeability in the blast furnace is required.

The present invention was made in view of the foregoing circumstances, and an objective thereof is to provide a method for producing pig iron and an iron ore material enabling improvement of gas permeability in the blast furnace.

### Means for Solving the Problems

The present inventors thoroughly investigated the segregation of the reduced iron to find that using reduced iron having a particular shape inhibits segregation, whereby the present invention was accomplished.

A method for producing pig iron according to an aspect of the present invention is a method for producing pig iron using a blast furnace comprising a tuyere, the method including: charging a first layer containing an iron ore material and a second layer containing coke alternately in the blast furnace; and reducing and melting the iron ore material in the charged first layer while injecting an auxiliary reductant into the blast furnace by hot air blown from the tuyere, in which: the iron ore material contains a plurality of reduced iron molded products obtained by compression molding reduced iron; the reduced iron molded product is in a rectangular shape chamfered in a plan view, having on both faces a bulge resulting from a center portion being thicker than a peripheral portion; and a length ratio of a longer side to a shorter side of the reduced iron molded product in the plan view is less than or equal to 1.5.

In the method for producing pig iron, the iron ore material in the first layer contains the reduced iron molded product, of which a length ratio of a longer side to a shorter side in the plan view is less than or equal to the upper limit. The reduced iron molded product is not likely to cause segregation during charging of the first layer, whereby gas flow in the blast furnace is made uniform and gas permeability in the blast furnace can be improved.

A proportion of the reduced iron molded product having a grain size of greater than or equal to 50 mm in the plurality of reduced iron molded products is preferably less than or equal to 10% by mass. The reduced iron molded product contained in the iron ore material is not likely to cause segregation during charging of the first layer, and can therefore inhibit segregation without depending on the reduced iron molded product having a large grain size. In addition, the reduced iron molded product having a large grain size has great drop impact energy during charging of the first layer, and is likely to be pulverized by the impact. Therefore, due to the proportion of the reduced iron molded product having a grain size of greater than or equal to 50 mm being less than or equal to the upper limit, the drop impact energy is decreased, pulverization or volume breakage is inhibited, and a charging yield of the reduced iron molded product is improved, whereby the gas permeability in the blast furnace can further be improved.

An iron ore material according to another aspect of the present invention is an iron ore material used for producing pig iron including a plurality of reduced iron molded products obtained by compression molding reduced iron, wherein: the reduced iron molded product is in a rectangular shape chamfered in a plan view, having on both faces a bulge resulting from a center portion being thicker than a peripheral portion; and a length ratio of a longer side to a shorter side of the reduced iron molded product in the plan view is less than or equal to 1.5.

The iron ore material includes the reduced iron molded product, of which a length ratio of a longer side to a shorter side in the plan view is less than or equal to the upper limit. The reduced iron molded product is not likely to cause segregation during charging of the iron ore material; thus, when the reduced iron molded product is used for production of pig iron, gas flow in the blast furnace is made uniform and gas permeability in the blast furnace can be improved.

As used herein, the “reduced iron molded product having a grain size of greater than or equal to 50 mm” as referred to means a reduced iron molded product remaining on a sieve having a 50 mm mesh after sifting.

### Effects of the Invention

As described above, the method for producing pig iron and the iron ore material according to the present invention can be utilized to achieve improvement of the gas permeability in the blast furnace.

### BRIEF DESCRIPTION OF THE DRAWINGS

FIG. 1 is a flow diagram illustrating the method for producing pig iron according to an embodiment of the present invention.

FIG. 2 is a schematic view illustrating the inside of the blast furnace used in the method for producing pig iron in FIG. 1.

FIG. 3 is a schematic perspective view illustrating a shape of a reduced iron molded product.

FIG. 4 is a schematic partial enlarged view of the vicinity of an area from a cohesive zone to a dripping zone in FIG. 2.

FIG. 5 is a schematic view illustrating a configuration of a blast furnace burden distribution experiment device used in EXAMPLES.

FIG. 6 is a graph showing proportions of the material in five radial directions in EXAMPLES in a case in which a dimension of an iron plate is 20 mm×7 mm×4 mm.

FIG. 7 is a graph showing proportions of the material in five radial directions in EXAMPLES in a case in which a dimension of an iron plate is 10 mm×7 mm×4 mm.

FIG. 8 is a graph showing a relationship between the number of tumbler rotations and a gas permeability resistance index during a tumbler rotation test in EXAMPLES.

FIG. 9 is a graph showing a relationship between a proportion of HBI having a grain size of greater than or equal to 50 mm and the gas permeability resistance index in EXAMPLES.

### DESCRIPTION OF EMBODIMENTS

Hereinafter, the method for producing pig iron according to each embodiment of the present invention will be described.

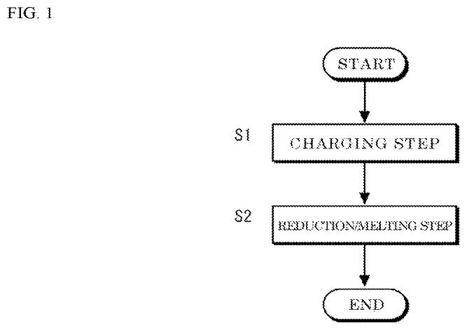

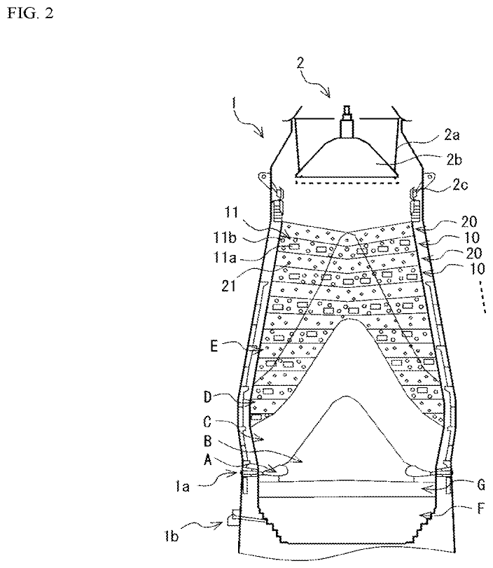

The method for producing pig iron illustrated in FIG. 1 uses a blast furnace 1 illustrated in FIG. 2, and includes a charging step S1 and a reduction/melting step S2.

### <Blast Furnace>

A blast furnace 1 includes, as shown in FIG. 2, a tuyere 1a and a taphole 1b provided in a lower portion of a furnace. In general, a plurality of tuyeres 1a are provided. The blast furnace 1 is a solid-gas countercurrent type shaft furnace that enables: hot air, which is high-temperature air with high-temperature or normal-temperature oxygen being added as needed, to be blown from the tuyere 1a into the furnace; a series of reactions such as reduction and melting of an iron ore material 11 described later to take place; and pig iron to be tapped from the taphole 1b. In addition, the blast furnace 1 is equipped with a bell-armor type raw material charging device 2. The raw material charging device 2 will be described later.

### <Charging Step>

In a charging step S1, as shown in FIG. 2, a first layer 10 and a second layer 20 are alternately charged in the blast furnace 1. In other words, the first layer 10 and the second layer 20 each have two or more layers.

### (First Layer)

The first layer 10 includes an iron ore material 11 which is itself an embodiment of the present invention. The iron ore material 11 is used for production of pig iron, and is heated and reduced into molten iron F by the hot air blown from the tuyere 1a in the reduction/melting step S2.

### [Iron Ore Material]

The “iron ore material” refers to mineral ore serving as an iron material, and contains principally iron ore. The iron ore material 11 contains a plurality of reduced iron molded products 11a obtained by compression molding reduced iron. The iron ore material 11 may contain, as other iron ore materials 11b, calcined iron ore (iron ore pellets, sinter), lump iron ore, carbon composite agglomerated iron ore, metal, and the like.

The reduced iron molded product 11a (Hot Briquette Iron, HBI) improves gas permeability in a cohesive zone D described later, and serves as an aggregate for causing the hot air to permeate to the central portion of the blast furnace 1.

The reduced iron molded product 11a is obtained by molding direct reduced iron (DRI) in a hot state. While the DRI has disadvantages of high porosity and exothermic oxidization during marine transportation and outdoor storage, the HBI has low porosity and is less likely to be reoxidized. After serving to ensure gas permeability in the first layer 10, the reduced iron molded product 11a functions as a metal and becomes molten iron. Since the reduced iron molded product 11a is high in metallization rate and requires no reduction, at the time of becoming the molten iron, the reduction agent is not required in a large amount. The CO₂ emission can thus be decreased. Note that the “metallization rate” as referred to means a proportion [% by mass] of the metallic iron with respect to the total iron content.

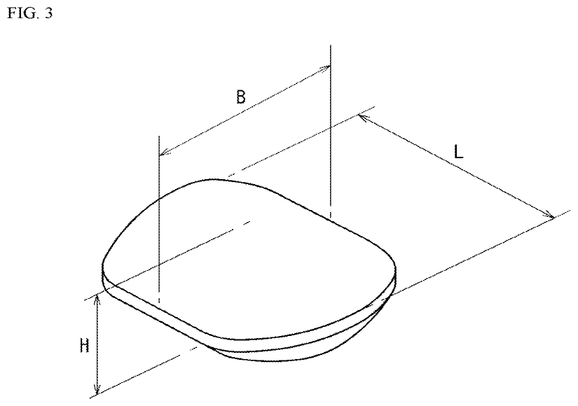

The reduced iron molded product 11a is generally produced by a twin roll molding device. At this time, as shown in FIG. 3, the reduced iron molded product 11a is in a rectangular shape chamfered in a plan view, having on both faces a bulge resulting from a center portion being thicker than a peripheral portion. Specifically, a contour of a cross section in a direction perpendicular to the longer side of the reduced iron molded product 11a bulges upward and downward in an arcuate shape with respect to a rectangular face. On the other hand, a contour of a cross section in a direction parallel to the longer side is in an arcuate shape upward and downward in the vicinity of each of shorter sides, and substantially parallel to the rectangular face in a center portion. Note that the contour of the cross section in the direction perpendicular to the longer side may also include a portion substantially parallel to the rectangular face in a center portion. Endpoints of the arcs extending upward and downward at the positions of the longer sides of the contour of the cross section in the direction perpendicular to the longer side, and the positions of the shorter sides of the contour in the direction parallel to the longer side may coincide or, as shown in FIG. 3, have a certain distance, between which the contour may have a linear portion extending upward and downward. In addition, a shape in a plan view is the chamfered rectangular shape as described above, in other words a rectangle with rounded corners. At least sides corresponding to the longer side are composed of rounded corners and straight lines, while sides corresponding to the shorter side may be composed of either rounded corners and straight lines, or only rounded corners as shown in FIG. 3. Note that the reduced iron molded product 11a may have a so-called burr particularly in a circumferential edge portion. In addition, the reduced iron molded product may be partially cracked due to a molding defect, or broken due to impact and/or the like during transportation or charging to the blast furnace, and such an incomplete reduced iron molded product may be contained in a part of the iron ore material; however, the “shape of the reduced iron molded product” as used to herein refers to a complete product, which does not include the incomplete reduced iron molded product, and means a shape of a main part of the reduced iron molded product without the burr.

A proportion of the reduced iron molded product 11a in which a length of the longer side of the reduced iron molded product 11a in a plan view (L in FIG. 3) is greater than or equal to 40 mm and less than or equal to 140 mm, a length of the shorter side of the reduced iron molded product 11a in a plan view (B in FIG. 3) is greater than or equal to 20 mm and less than or equal to 70 mm, and a thickness of the reduced iron molded product 11a (height of a thick part of the central portion, H in FIG. 3) is greater than or equal to 20 mm and less than or equal to 50 mm is preferably greater than or equal to 50% by mass, more preferably greater than or equal to 70% by mass, and still more preferably greater than or equal to 80% by mass.

In addition, the upper limit of a ratio of the longer side L to the shorter side B (L/B) of the reduced iron molded product 11a in a plan view is 1.5, and more preferably 1.4. When L/B is greater than the upper limit, the reduced iron molded product 11a may be more likely to segregate when the iron ore material 11 is charged in the first layer 10. On the other hand, the lower limit of L/B is 1.0, since the longer side≥the shorter side.

The upper limit of the proportion of the reduced iron molded product 11a having a grain size of greater than or equal to 50 mm in the plurality of reduced iron molded products 11a is preferably 10% by mass, and more preferably 8% by mass. The reduced iron molded product 11a contained in the iron ore material 11 is not likely to cause segregation during charging of the first layer 10, and can therefore inhibit segregation without depending on the reduced iron molded product 11a having a large grain size. In addition, the reduced iron molded product 11a having a large grain size has great drop impact energy during charging of the first layer 10, and is likely to be pulverized by the impact. Therefore, when the proportion of the reduced iron molded product 11a having a grain size of greater than or equal to 50 mm is less than or equal to the upper limit, the drop impact energy is decreased, pulverization or volume breakage is inhibited, and a charging yield of the reduced iron molded product 11a is improved, whereby the gas permeability in the blast furnace can further be improved.

The upper limit of a content of the reduced iron molded product 11a in the iron ore material 11 is preferably 30% by mass, and more preferably 25% by mass. When the content of the reduced iron molded product 11a is less than or equal to the upper limit, the segregation can be inhibited, whereby the ore inclined angle is stabilized at a low level. As a result, the reduced iron molded product 11a can be present in the first layer 10 relatively homogeneously, whereby the hot air can be ensured to permeate to the central portion of the blast furnace 1. Therefore, the amount of coke 21 used can be decreased. In addition, instability of the first layer 10 due to the segregation of the reduced iron molded product 11a can be avoided, whereby layer collapse can be inhibited when melting occurs from a lower side and an upper layer descends in the reduction/melting step S2. Note that the ore inclined angle refers to an angle of an inclined face of an iron ore deposition layer (such as the first layer 10) from the horizon.

The lower limit of a charged rate of the reduced iron molded product 11a is preferably 100 kg and more preferably 150 kg per 1 ton of the pig iron. When the charged rate of the reduced iron molded product 11a is less than the lower limit, the function of the reduced iron molded product 11a ensuring gas permeability in the cohesive zone D in the reduction/melting step S2 may not be sufficiently exerted. On the other hand, the upper limit of the charged rate of the reduced iron molded product 11a is defined as appropriate in such a range that the aggregate is not excessive and does not decrease the effect of the aggregate, and is, for example, 700 kg per 1 ton of the pig iron.

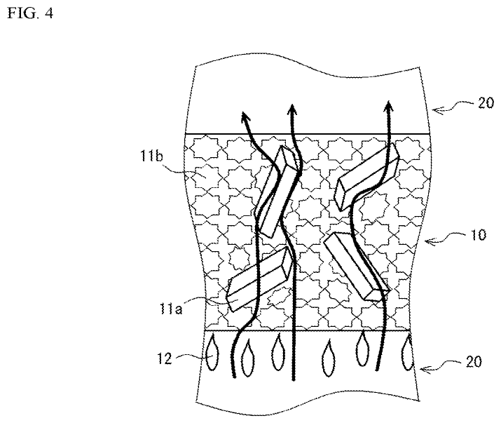

The lower limit of a ratio of an average grain size of the reduced iron molded product 11a to an average grain size of the other iron ore materials 11b is preferably 1.3, and more preferably 1.4. As illustrated in FIG. 4, even when a part of the other iron ore materials 11b in the first layer 10 is melted and moves to the lower side of the blast furnace 1 as dripping slag 12 and the other iron ore materials 11b having moved are softened and shrunk, the reduced iron molded product, having a high melting point, is not softened. Blending the reduced iron molded product 11a, which is larger than the other iron ore materials 11b to at least a certain degree, as the aggregate facilitates the aggregate effect of the reduced iron molded product 11a to be exerted and enables suppression of layer shrinkage of the entire first layer 10. Consequently, when the ratio of the average grain sizes is greater than or equal to the lower limit, a channel of the hot air shown by an arrow in FIG. 4 can be secured, whereby gas permeability in the reduction/melting step S2 can be improved. Meanwhile, the upper limit of the ratio of the average grain sizes is preferably 10 and more preferably 5. When the ratio of the average grain sizes is greater than the upper limit, it may be difficult to blend the reduced iron molded product 11a uniformly into the first layer 10, leading to an increase in segregation. Note that the “average grain size” as referred to means such a grain size that an accumulated mass is 50% in a grain size distribution.

In addition, when the reduced iron molded product 11a contains aluminum oxide, the upper limit of the content of the aluminum oxide in the reduced iron molded product 11a is preferably 1.5% by mass and more preferably 1.3% by mass. When the content of the aluminum oxide is greater than the upper limit, ensuring of the gas permeability in a lower position of the furnace may be difficult due to a higher melting point of the slag and increased viscosity. Consequently, by configuring the content of aluminum oxide in the reduced iron molded product 11a to be less than or equal to the upper limit, an increase in the amount of the coke 21 used in the second layer 20 described later can be inhibited. Note that the content of the aluminum oxide may be 0% by mass, in other words the reduced iron molded product 11a may not contain the aluminum oxide, but the lower limit of the content of the aluminum oxide is preferably 0.5% by mass. When the content of the aluminum oxide is less than the lower limit, the reduced iron molded product 11a may become expensive and the production cost of the pig iron may increase.

In addition to the iron ore material 11, auxiliary materials such as limestone, dolomite, and silica may also be charged into the first layer 10. Furthermore, in the first layer 10, undersize small-grain coke obtained by sifting the coke is generally used in mixture, in addition to the iron ore material 11.

### (Second Layer)

The second layer 20 contains the coke 21.

The coke 21 serves: as a heat source for melting the iron ore material 11; to generate CO gas as a reducing agent necessary for reduction of the iron ore material 11; as a recarburizing agent for carburizing the molten iron to lower the melting point, and as a spacer for ensuring gas permeability in the blast furnace 1.

### (Charging Method)

Various methods can be used as a method for alternately charging the first layer 10 and the second layer 20. The method is described herein with reference to the blast furnace 1 equipped with the bell-armor type raw material charging device 2 as shown in FIG. 2 (hereinafter, may be also merely referred to as “raw material charging device 2”).

The raw material charging device 2 is provided in a furnace top portion. In other words, the first layer 10 and the second layer 20 are charged from the furnace top. The raw material charging device 2 includes a bell cup 2a, a lower bell 2b, and an armor 2c as shown in FIG. 2.

In the bell cup 2a, the raw material to be charged is loaded. When the first layer 10 is charged, a raw material constituting the first layer 10 is loaded into the bell cup 2a, and when the second layer 20 is charged, a raw material constituting the second layer 20 is loaded.

The lower bell 2b is in a cone shape expanding downward, and is provided in the bell cup 2a. The lower bell 2b is vertically movable (in FIG. 2, a solid line shows a state in which the lower bell has moved upward and a dotted line shows a state in which the lower bell has moved downward). The lower bell 2b moves upward to hermetically seal a lower portion of the bell cup 2a, and moves downward to leave a gap on an extended line of a lateral wall of the bell cup 2a.

The armor 2c is provided on a furnace wall portion of the blast furnace 1, below the lower bell 2b. When the lower bell 2b is moved downward, the raw material falls through the gap. The armor 2c serves as a rebound plate for rebounding the fallen raw material. In addition, the armor 2c is configured to be protrudable and retractable with respect to a center of the blast furnace 1.

By using the raw material charging device 2, the first layer 10 can be charged as follows. Note that the same applies to the second layer 20. In addition, the first layer 10 and the second layer 20 are alternately charged.

First, the lower bell 2b is positioned upward and the raw material of the first layer 10 is charged into the bell cup 2a. When the lower bell 2b is positioned upward, the lower portion of the bell cup 2a is hermetically sealed and the raw material is loaded into the bell cup 2a. Note that the loading amount thereof is a charging amount of each layer. In a case in which a capacity of the bell cup 2a is smaller than a charging amount of each layer, the first layer 10 can be charged in a plurality of installments. The charging with a single load may be also referred to as a “batch”.

Next, the lower bell 2b is moved downward. As a result, a gap is formed with respect to the bell cup 2a, and the raw material falls through the gap to hit the armor 2c. The raw material having hit and been rebounded by the armor 2c is charged into the furnace. The raw material falls while moving in an inward direction of the furnace due to rebounding at the armor 2c, and accumulates while flowing from the fallen position toward a central side of the furnace interior. Since the armor 2c is configured to be protrudable and retractable with respect to the inside of the blast furnace, the fallen position of the raw material can be adjusted by protruding and retracting the armor 2c. Due to this adjustment, the first layer 10 can be accumulated in a desired shape.

### <Reduction/Melting Step>

In the reduction/melting step S2, the iron ore material 11 in the charged first layer 10 is reduced and melted while an auxiliary reductant is injected into the blast furnace 1 by hot air blown from the tuyere 1a. Note that the operation of the blast furnace is continuous, and thus the reduction/melting step S2 is carried out continuously. On the other hand, the charging step S1 is carried out intermittently, and the first layer 10 and the second layer 20 to be processed in the reduction/melting step S2 are added according to the circumstances of the reduction and melting process of the first layer 10 and the second layer 20 in the reduction/melting step S2.

FIG. 2 illustrates a state in the reduction/melting step S2. As shown in FIG. 2, a raceway A, which is a hollow portion in which the coke 21 swivels and is present in a significantly sparse state, is formed in the vicinity of the tuyere 1a, due to the hot air from the tuyere 1a. In the blast furnace 1, the temperature of the raceway A is the highest, being about 2,000° C. A deadman B, which is an aggregation-stagnation zone of the coke inside the blast furnace 1, is present adjacent to the raceway A. In addition, the dripping zone C, the cohesive zone D, and the lumpy zone F are present in an upward direction in this order from the deadman B.

The temperature in the blast furnace 1 increases from the top portion toward the raceway A. In other words, the temperature increases in the order of the lumpy zone E, the cohesive zone D, and the dripping zone C. For example, the temperature of the lumpy zone E is about greater than or equal to 20° C. and less than or equal to 1,200° ° C., while the temperature of the deadman B is about greater than or equal to 1,200° C. and less than or equal to 1,600° C. Note that the temperature of the deadman B varies in the radial direction, and the temperature of a central portion of the deadman B may be lower than the temperature of the dripping zone C. In addition, by stably circulating the hot air in the central portion in the furnace, the cohesive zone D having an inverted V-shaped cross section is formed, whereby gas permeability and reducibility are ensured in the furnace.

In the blast furnace 1, the iron ore material 11 is first heated and reduced in the lumpy zone E. In the cohesive zone D, the iron ore reduced in the lumpy zone E is softened and shrunk. The softened and shrunk iron ore falls as the dripping slag, and moves to the dripping zone C. In the reduction/melting step S2, reduction of the iron ore material 11 proceeds principally in the lumpy zone E, while melting of the iron ore material 11 proceeds principally in the dripping zone C. Note that in the dripping zone C and the deadman B, direct reduction proceeds, which is a direct reaction between the fallen liquid iron oxide FeO and carbon in the coke 21.

The reduced iron molded product 11a exerts the aggregate effect in the cohesive zone D. In other words, even in a state in which the iron ore is softened and shrunk, the reduced iron molded product 11a having a high melting point is not softened, and secures a gas permeation channel ensuring permeation of the hot air to the central portion of the blast furnace 1.

In addition, the molten iron F obtained by melting the reduced iron is accumulated on a hearth, and molten slag G is accumulated on the molten iron F. The molten iron F and the molten slag G can be tapped from the taphole 1b.

### <Advantages>

The iron ore material 11 includes the reduced iron molded product 11a, of which a length ratio of a longer side to a shorter side in the plan view is less than or equal to 1.5. The reduced iron molded product 11a is not likely to cause segregation during charging of the iron ore material 11; thus, when the reduced iron molded product is used for production of pig iron, gas flow in the blast furnace 1 is made uniform and gas permeability in the blast furnace 1 can be improved.

In addition, in the method for producing pig iron, the iron ore material 11 according to the present invention is charged in the first layer 10, whereby a gas flow in the blast furnace 1 is made uniform and the gas permeability in the blast furnace 1 can be improved.

### Other Embodiments

It is to be noted that the present invention is not limited to the above-described embodiments.

In the above-described embodiment, regarding the iron ore material of the present invention, a case of containing the reduced iron molded product and the other iron ore materials has been described; however, the iron ore material of the present invention may contain only the reduced iron molded product. Such an iron ore material can be blended with other types of iron ore materials as needed, and included in the first layer charged in the blast furnace.

In the above-described embodiment, the method for producing pig iron of the present invention including only the charging step and the reduction/melting step has been described; however, the method for producing pig iron may include other steps.

For example, the method for producing pig iron may include a step of charging a mixture of the coke and the reduced iron molded product to the central portion of the blast furnace. In this case, it is preferred that the proportion of the reduced iron molded product 11a having a grain size of greater than or equal to 5 mm is greater than or equal to 90% by mass in the reduced iron molded products in the mixture, and the content of the reduced iron molded product in the mixture is less than or equal to 70% by mass. The hot air that has reached the central portion of the blast furnace goes up in the central portion. Due to the reduced iron molded product having a large grain size included in the central portion in a content less than or equal to the upper limit, the sensible heat can be effectively used without encumbering the flow of the hot air. Therefore, the amount of coke used can further be decreased. As used herein, the “central portion” of the blast furnace refers to a region at a distance of no greater than 0.2Z from the center, Z being a radius of a furnace throat portion.

In addition, the method for producing pig iron may include a step of finely pulverizing powder derived from the reduced iron molded product and coal. In this case, it is preferred that the fine powder obtained by the fine pulverizing step is included as the auxiliary reductant. A part of the reduced iron molded product is pulverized into powder during a transportation process and/or the like. Such powder lowers the gas permeability in the blast furnace, and is inappropriate for use as the first layer. In addition, this powder has a great specific surface area, and is reoxidized into iron oxide. Injecting the auxiliary reductant containing the iron oxide from the tuyere enables improvement of gas permeability. Consequently, by finely pulverizing powder derived from the reduced iron molded product together with coal and using fine powder obtained by finely pulverizing the powder and the coal as the auxiliary reductant to be injected from the tuyere, the reduced iron molded product can be effectively used and gas permeability in the blast furnace can be improved.

Although the case of employing the bell-armor type as the charging step according to the above-described embodiment has been described, other types may also be employed. Examples of the other types include a bell-less type. With the bell-less type, charging can be carried out by using a swivel chute and adjusting the angle thereof.

### Examples

Hereinafter, the present invention is explained in further detail by way of Examples, but the present invention is not in any way limited to these Examples.

### <Shape of Reduced Iron Molded Product>

First, an experiment was conducted regarding an influence of the shape of the reduced iron molded product on segregation.

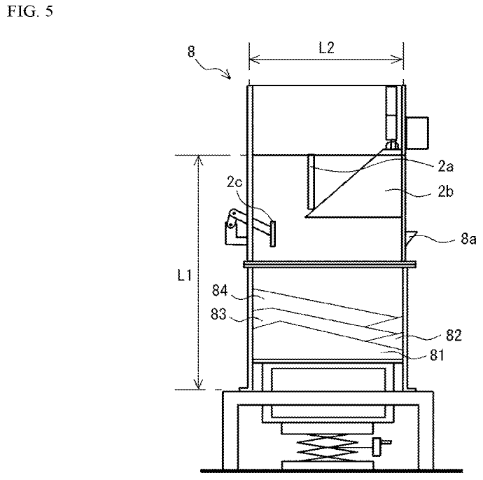

FIG. 5 illustrates a blast furnace burden distribution experiment device 8 used in this experiment. The blast furnace burden distribution experiment device 8 illustrated in FIG. 5 is a two-dimensional slice cold model simulating the bell-armor type raw material charging device on a scale of 1/10.7. The size of the blast furnace burden distribution experiment device 8 is 1,450 mm in height (length L1 in FIG. 5), 580 mm in width (length L2 in FIG. 5), and 100 mm in depth (length in a direction perpendicular to a sheet surface of FIG. 5).

Each constitutive element of the blast furnace burden distribution experiment device 8 is denoted by the same reference numeral as the corresponding constitutive element having the same function of the bell-armor type raw material charging device 2 in FIG. 2. Since the function is the same, detailed description thereof is omitted. In addition, the blast furnace burden distribution experiment device 8 includes a center charging chute 8a for charging the coke, simulating central charging, as shown in FIG. 5.

A coke layer 81 as a base, a center charged coke layer 82, a first iron ore layer 83, and a second iron ore layer 84 were charged in this order to the blast furnace burden distribution experiment device 8.

Raw materials used for charging the first iron ore layer 83 and the second iron ore layer 84 were: sinter simulating sinter and lump iron ore (2.8 to 4.0 mm in grain size); alumina balls simulating the iron ore pellets (2 mm in diameter); coke simulating lump coke (8.0 to 9.5 mm in grain size), and an iron plate simulating the reduced iron molded product (HBI). The raw materials were on a scale of 2/11.2. Meanwhile, a mass ratio of the HBI/sinter/alumina balls was 18.5% by mass/32.6% by mass/48.9% by mass.

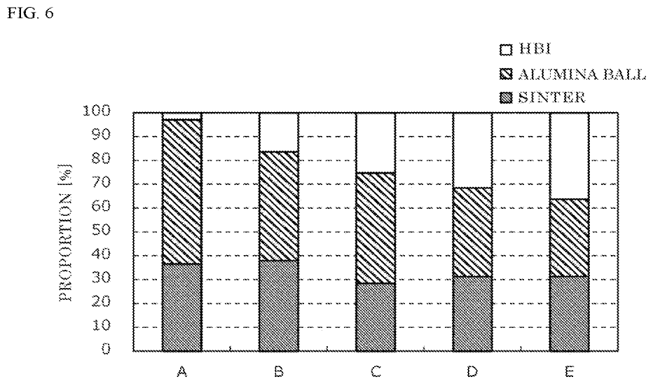

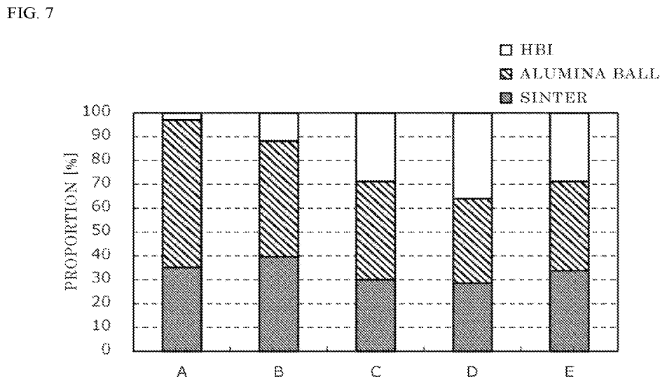

Under the above-specified conditions, with the iron plates simulating the HBI having the sizes of 20 mm×7 mm×4 mm (length ratio L/B of a longer side to a shorter side=2.86) and 10 mm×7 mm×4 mm (L/B=1.43), iron ore samples were obtained after charging in five positions (A to E) in a radial direction, and proportions of each raw material were determined. The results in the case of L/B=2.86 are shown in FIG. 6, and the results in the case of L/B=1.43 are shown in FIG. 7.

As shown in FIG. 5, the first iron ore layer 83 and the second iron ore layer 84 accumulated in a downward inclined manner toward the vicinity of the center. In this case, the HBI having a great individual weight tends to segregate in the vicinity of the center, which is on a lower side. FIG. 6 shows that in the case of L/B=2.86, the proportion of the HBI in the vicinity of the center increased and segregation occurred. Note that the small proportion of the HBI in A and B, being close to the periphery, was intentional. In other words, this is due to control such that the proportion of the HBI is decreased during charging of the raw material, since the gas permeability is easily ensured in the periphery.

In contrast, although the individual weight was sufficiently greater than that of the sinter and the alumina ball in the case of L/B=1.43 as well, the proportion of the HBI was relatively stable in C to E, being close to an intermediate position to the vicinity of the center, as shown in FIG. 7, and the segregation was inhibited as compared to the case of L/B=2.86 in FIG. 6.

The foregoing shows that the length ratio of the longer side to the shorter side of the reduced iron molded product being less than or equal to 1.5 can inhibit segregation during charging of the iron ore material.

### <Grain Size of Reduced Iron Molded Product>

Next, an experiment was conducted regarding an influence of the grain size of the reduced iron molded product on the gas permeability resistance index.

First, an influence of a difference in the drop impact energy due to difference in grain size on the gas permeability resistance index was investigated. Specifically, a tumbler rotation test was conducted in order to subject the HBI to an impact simulating a transportation state.

The tumbler rotation test of the HBI was conducted pursuant to JIS-M8712:2000 “Iron ores (pellets, sinter)—Determination of tumble strength”. The rotary drum was made of a steel plate having a thickness of 6 mm, an inner diameter of 1,000 mm, and a length of 500 mm. On an inner face, two blades made of equal-angle steel of 50 mm×50 mm×6 mm were attached in an axial direction in symmetrical positions. An attachment face thereof was opposite to a rotational direction, whereby the sample was easily lifted by rotation.

The sample used was dried HBI of 15±0.15 kg. The test was conducted while changing details of the size of the sample (changing proportions of large-sized HBI and small-sized HBI). Note that the large-sized HBI refers to HBI having a grain size of greater than or equal to 40 mm and less than or equal to 100 mm, and the small-sized HBI refers to HBI having a grain size of greater than or equal to 20 mm and less than 40 mm.

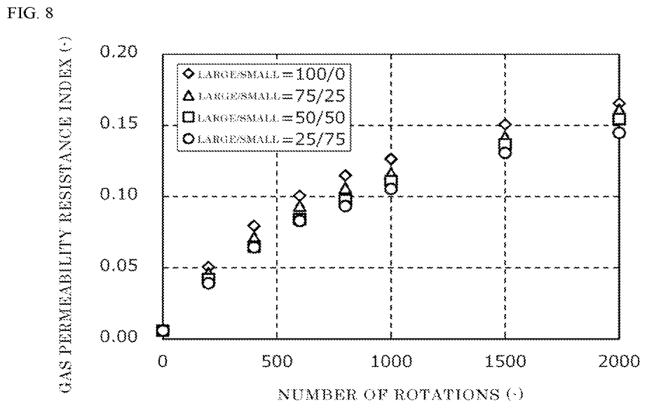

After rotating the rotary drum a predetermined number of times at a rotation speed of 25±1 rpm, a gas permeability resistance index K was calculated as follows. Specifically, the following procedure was followed. After conducting the tumbler rotation test, a grain size distribution of the reduced iron molded product was obtained by sieving. The grain size distribution is expressed with dᵢ [cm] as a representative grain size (median value) between meshes used for the sieving, and wᵢ as a weight fraction of the reduced iron molded product falling into the representative grain size dᵢ. Using this grain size distribution, a harmonic mean diameter Dₚ [cm] and a granularity composition index Isp were calculated by the following equation 1. Furthermore, by using the gravitational conversion factor g_{c} [9.807 (g·cm)/(G·sec²)], the gas permeability resistance index K was obtained by the following equation 1. The results are shown in FIG. 8.

$$\begin{matrix}[ Math . 1 ] & \\ \begin{matrix}{D}_{p} = 1 / ( \sum {w}_{i} / {d}_{i} ) \\ {I}_{sp} = 100 \times \sqrt{{I}_{s} \times {I}_{p}} \\ wherein , {I}_{s} = {D}_{p}^{2} \times \sum {w}_{i} \times {( 1 / {d}_{i} - 1 / {D}_{p} )}^{2} \\ {I}_{p} = 1 / {D}_{p}^{2} \times \sum {w}_{i} \times {( {d}_{i} - {D}_{p} )}^{2} \\ K = C \times ( {1.06}^{{I}_{sp}^{n}} ) / ( {g}_{c} \times {D}_{p}^{1.5} ) \\ wherein , n = 0.47 , C = 0.55\end{matrix} & 1\end{matrix}$$

The results in FIG. 8 show that when the number of tumbler rotations increased and accumulated rotation drop impact increased, the HBI was destroyed and the gas permeability resistance index K increased. On the other hand, with the same number of rotations, comparison shows that when the proportion of the large-sized HBI increased and the proportion of the small-sized HBI decreased, the gas permeability resistance index K increased. The reason therefor is inferred to be an increase in drop impact due to an increase in the individual weight.

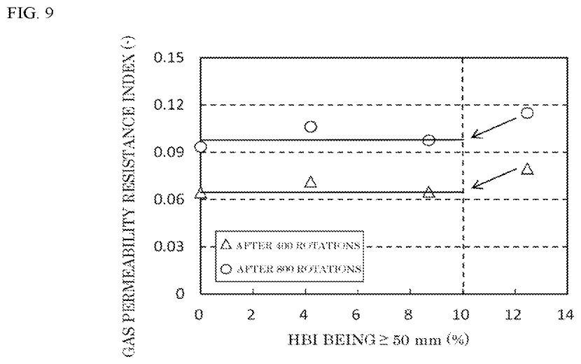

Given this, the proportion of the HBI having a grain size of greater than or equal to 50 mm was changed, and the above-described tumbler rotation test was conducted with 400 and 800 rotations to calculate the gas permeability resistance index K. The results are shown in FIG. 9.

The results in FIG. 9 show that the proportion of the HBI having a grain size of greater than or equal to 50 mm being less than or equal to 10% by mass enabled inhibition of pulverization and volume breakage during transportation and charging to the blast furnace. As a result, a charging yield of the HBI and the gas permeability in the blast furnace can be improved.

### INDUSTRIAL APPLICABILITY

The method for producing pig iron and the iron ore material according to the present invention can be utilized to achieve improvement of the gas permeability in the blast furnace.

### EXPLANATION OF THE REFERENCE SYMBOLS

1 Blast furnace
1a Tuyere
1b Taphole
2 Raw material charging device
2a Bell cup
2b Lower bell
2c Armor
10 First layer
11 Iron ore material
11a Reduced iron molded product
11b Other iron ore materials
12 Dripping slag
20 Second layer
21 Coke
8 Blast furnace burden distribution experiment device
8a Center charging chute
81 Coke layer
82 Center charged coke layer
83 First iron ore layer
84 Second iron ore layer
A Raceway
B Deadman
C Dripping zone
D Cohesive zone
E Lumpy zone
F Molten iron
G Molten slag

1. A method for producing pig iron with a blast furnace comprising a tuyere, the method comprising:
charging a first layer comprising an iron ore material and a second layer comprising coke alternately in the blast furnace; and
reducing and melting the iron ore material in the charged first layer while injecting an auxiliary reductant into the blast furnace by hot air blown from the tuyere, wherein:
the iron ore material comprises a plurality of reduced iron molded products obtained by compression molding reduced iron;
the reduced iron molded product is in a rectangular shape chamfered in a plan view, having on both faces a bulge resulting from a center portion being thicker than a peripheral portion; and
a length ratio of a longer side to a shorter side of the reduced iron molded product in the plan view is less than or equal to 1.5.

2. The method for producing pig iron according to claim 1, wherein a proportion of the reduced iron molded product having a grain size of greater than or equal to 50 mm in the plurality of reduced iron molded products is less than or equal to 10% by mass.

3. An iron ore material for producing pig iron
comprising a plurality of reduced iron molded products obtained by compression molding reduced iron, wherein:
the reduced iron molded product is in a rectangular shape chamfered in a plan view, having on both faces a bulge resulting from a center portion being thicker than a peripheral portion; and
a length ratio of a longer side to a shorter side of the reduced iron molded product in the plan view is less than or equal to 1.5.
